(19) United States
(12) Patent Application Publication
(10) Pub. No.: US 2019/0180755 A1
(43) Pub. Date: Jun. 13, 2019

(54) VOICE RECOGNITION DEVICE

(71) Applicant: Onkyo Corporation, Osaka (JP)

(72) Inventors: Takanori Shiozaki, Osaka (JP); Takayuki Goto, Osaka (JP)

(21) Appl. No.: 16/212,796

(22) Filed: Dec. 7, 2018

(30) Foreign Application Priority Data
Dec. 11, 2017 (JP) 2017-236698

(51) Int. Cl. G10L 15/32; G10L 25/84; G10L 21/0232; G10L 15/22

(52) U.S. Cl. CPC G10L 15/32; G10L 15/22; G10L 21/0232; G10L 25/84

(57) ABSTRACT

A voice recognition device comprising: a battery; a first voice recognition section which performs voice recognition; and a second voice recognition section which performs voice recognition and in which electric power consumption is higher than the first voice recognition section; wherein the second voice recognition section performs voice recognition when driving by electric power from an external power supply, and the first voice recognition section performs voice recognition when driving by electric power from the battery.

### CROSS-REFERENCE TO RELATED APPLICATIONS

This application claims priority to Japanese Application No. 2017-236698, filed Dec. 11, 2017, the entire contents of which are incorporated herein by reference.

### FIELD

The present disclosure relates to a voice recognition device which performs voice recognition.

### BACKGROUND

As a device which performs voice recognition, there are a device with low electric power consumption (for example, a DSP (Digital Signal Processor)) and a device with high electric power consumption (for example, an SoC (System on Chip)) (for example, see JP 2017-050010 A). A voice recognition rate of the device with low electric power consumption is low. A voice recognition rate of the device with high electric power consumption is high.

In a voice recognition device which mounts a battery, when the voice recognition device with high electric power consumption is used, there is a problem that electric power consumption of the battery is high and the time during which the device can operate is shortened.

### SUMMARY OF THE INVENTION

According to one aspect of the disclosure, there is provided a voice recognition device comprising: a battery; a first voice recognition section which performs voice recognition; and a second voice recognition section which performs voice recognition and in which electric power consumption is higher than the first voice recognition section; wherein the second voice recognition section performs voice recognition when driving by electric power from an external power supply, and the first voice recognition section performs voice recognition when driving by electric power from the battery.

### BRIEF DESCRIPTION OF THE DRAWINGS

FIG. 1 is a block diagram illustrating a constitution of a voice recognition device according to an embodiment of the present invention.

### DETAILED DESCRIPTION OF THE PREFERRED EMBODIMENTS

An objective of the present invention is to suppress electric power consumption when being driven by a battery in a voice recognition device which mounts the battery.

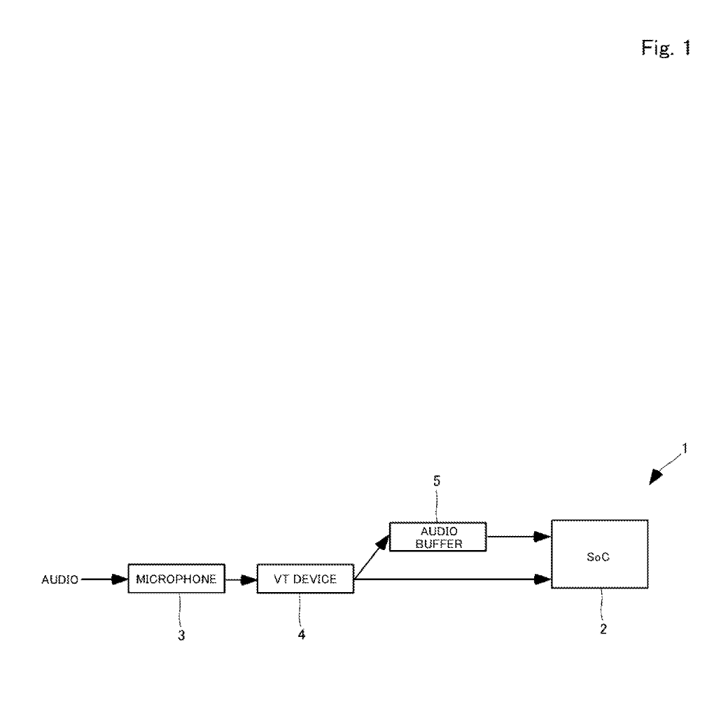

An embodiment of the present invention is described below. FIG. 1 is a block diagram illustrating a constitution of a voice recognition device according to an embodiment of the present invention. As illustrated in FIG. 1, the voice recognition device 1 includes an SoC (System on Chip) 2, a microphone 3, a VT (Voice Trigger) device 4, and an audio buffer 5.

The SoC 2 (second voice recognition section) controls each section composing of the voice recognition device 1. Further, the SoC 2 performs voice recognition. The microphone 3 collects audio. Audio which is collected by the microphone 3 is output to the VT device 4. The VT device 4 (first voice recognition section) performs noise filter processing and voice recognition to input audio. For example, the VT device 4 is a dedicated low electric power consumption DSP (Digital Signal Processor) which is specialized to voice recognition. Audio which input to the VT device 4 is output to the audio buffer 5 or the SoC 2. The audio buffer 5 is a memory to save input audio. Audio which is saved in the audio buffer 5 is output to the SoC 2. The audio buffer 5 may be a memory within the VT device 4.

The voice recognition device 1 is driven by electric power from an external power supply (for example, AC power supply). The voice recognition device 1 further includes a battery. When the voice recognition device 1 is not connected to the external power supply, the voice recognition device 1 is driven by electric power from the battery. The battery is charged by electric power from the external power supply.

### First Embodiment

When driving by electric power from the battery, the VT device 4 performs voice recognition. In this time, the SoC 2 is in a sleep state. Further, when driving by electric power from the external power supply, the SoC 2 performs voice recognition. Electric power consumption of the VT device 4 is lower than the SoC 2. Electric power consumption of the SoC 2 is higher than the VT device 4. Further, a voice recognition rate of the VT device 4 is lower than the SoC 2. A voice recognition rate of the SoC 2 is higher than the VT device 4. In a first embodiment, as described above, when driving by electric power from the battery, the VT device 4 in which electric power consumption is lower than the SoC 2 performs voice recognition. Thus, electric power consumption when driving by the battery can be suppressed. When the SoC 2 is activated and voice recognition service (function) is enabled, for example, electric power of 100 to 500 mW is consumed. In the first embodiment, when driving by the battery, electric power consumption of the SoC 2 which is described above can be reduced. Electric power consumption of the SoC 2 is not more than 100 mW in the sleep state.

Further, as described above, in the first embodiment, when driving by electric power from the external power supply, the SoC 2 in which the voice recognition rate is higher than the VT device 4 performs voice recognition. For this reason, when driving by electric power from the external power supply, electric power consumption increases. However, there is an advantage that performance of voice recognition rises. When driving by electric power from the external power supply, the VT device 4 performs noise filter processing to input audio and outputs audio to which the noise filter processing is performed to the SoC 2. Alternatively, the VT device 4 outputs (passes through) input audio to the SoC 2 as it is.

When driving by electric power from the battery and a high voice recognition rate is necessary, the SoC 2 performs voice recognition. Thus, even when driving by electric power from the battery and the high voice recognition rate is necessary, voice recognition can be performed by the SoC 2 in which the voice recognition rate is high.

### Second Embodiment

In a second embodiment, as the first embodiment, when driving by electric power from the battery, the VT device 4 performs voice recognition. In this time, the SoC 2 is in a sleep state. When the VT device 4 successes voice recognition, it activates the SoC 2. Next, the VT device 4 outputs audio which is input from the microphone 3 to the audio buffer 5. The audio buffer 5 saves input audio. Audio which is saved in the audio buffer 5 is output to the SoC 2. The SoC 2 performs voice recognition. For example, the VT device 4 performs voice recognition of a trigger word for enabling a voice recognition function by the voice recognition device 1, when it successes voice recognition, it performs subsequent processing. For this reason, when driving by electric power from the battery, the VT device 4 performs voice recognition of the trigger word, and it successes voice recognition, it activates the SoC 2. Thus, electric power consumption of the SoC 2 can be reduced.

Further, after the VT device 4 in which the voice recognition rate is low performs voice recognition, the SoC 2 in which the voice recognition rate is high performs voice recognition. Thus, electric power consumption can be suppressed and accuracy of voice recognition can be increased.

Further, in the second embodiment, audio which is saved in the audio buffer 5 is output to the SoC 2. Therefore, until the SoC 2 activates, audio which is input to the SoC 2 can be delayed by the audio buffer 5.

When time is not needed at the timing when the SoC 2 activates from the sleep state, the VT device 4 may activate the SoC 2 and output input audio to the SoC 2.

The embodiments of the present invention are described above, but the mode to which the present invention is applicable is not limited to the above embodiments and can be suitably varied without departing from the scope of the present invention.

The present disclosure can be suitably employed in a voice recognition device which performs voice recognition.

What is claimed is:

1. A voice recognition device comprising:
a battery;
a first voice recognition section which performs voice recognition; and
a second voice recognition section which performs voice recognition and in which electric power consumption is higher than the first voice recognition section;
wherein the second voice recognition section performs voice recognition when driving by electric power from an external power supply, and
the first voice recognition section performs voice recognition when driving by electric power from the battery.

2. The voice recognition device according to claim 1,
wherein a voice recognition rate of the second voice recognition section is higher than the first voice recognition section.

3. The voice recognition device according to claim 1,
wherein the first voice recognition section outputs input audio to the second voice recognition section when driving by electric power of the external power supply.

4. The voice recognition device according to claim 1,
wherein the first voice recognition section performs noise filter processing to input audio and outputs audio to which the noise filter processing is performed to the second voice recognition section.

5. The voice recognition device according to claim 1,
wherein the second voice recognition section is in a sleep state when driving by electric power from the battery.

6. The voice recognition device according to claim 1,
wherein the first voice recognition section activates the second voice recognition section which is in the sleep state when the first voice recognition section successes voice recognition and outputs the input audio to the second voice recognition section,
and the second voice recognition section performs voice recognition.

7. The voice recognition device according to claim 1 further comprising: an audio buffer for saving audio which is output from the first voice recognition section,
wherein the first voice recognition section activates the second voice recognition section in the sleep state when the first voice recognition section successes voice recognition and outputs the input audio to the audio buffer,
the audio which is saved in the audio buffer is output to the second voice recognition section, and
the second voice recognition section performs voice recognition.

8. The voice recognition device according to claim 1,
wherein the second voice recognition section performs voice recognition when driving by electric power from the external power supply or driving by electric power from the battery and a high voice recognition rate is necessary.
